(19) United States
(12) Patent Application Publication
(10) Pub. No.: US 2007/0120956 A1
(43) Pub. Date: May 31, 2007

(54) COMMUNICATION PATH SETTING METHOD AND COMMUNICATION APPARATUS

(76) Inventor: Kazunari Watanabe, Yokohama-shi (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/563,300

(22) Filed: Nov. 27, 2006

(30) Foreign Application Priority Data
Nov. 28, 2005 (JP) 2005-342842

(51) Int. Cl. H04N 7/14

(52) U.S. Cl. 348/14.01

(57) ABSTRACT

A communication path setting method of a communication system including a communication apparatus and a plurality of wireless terminals accommodated in the communication apparatus records the statuses of the plurality of accommodated wireless terminals. When transferring data between wireless terminals, the method selects a first communication path which connects the wireless terminals via the communication apparatus, or a second communication path which directly connects the wireless terminals without going via the communication apparatus, in accordance with the statuses of the wireless terminals. The method sets the selected communication path, and transfers the data between the wireless terminals.

### BACKGROUND OF THE INVENTION

1. Field of the Invention

The present invention relates to a communication path setting technique.

2. Description of the Related Art

A video display device such as a television set which displays various video data obtained by a video input device on its screen generally has no internal means for storing a large amount of video data. To display various video data on the screen, therefore, the video input device as a video data transmission source must transmit video data in the form of streaming to the video display device. The video display device displays the image on the screen in real time while receiving the transmitted video stream.

A wireless communication path is one video streaming transmission path. For example, a mechanism proposed for a wireless LAN guarantees a special transmission band for data, such as audio data or video data distributed by streaming, which must be transmitted in real time. For example, a scheme (e.g., IEEE 802.11e) which sets the priority order in accordance with the type of data to be transmitted, and preferentially transmits data having a high priority order is examined and proposed as a means for implementing a QoS technique.

This QoS technique can use a wireless communication path formed via a control station such as an access point, and a wireless communication path formed directly between apparatuses. Selective use of these communication paths requires control which selects the optimum communication path.

Patent reference 1 (Japanese Patent Laid-Open No. 2004-23613) describes a wireless communication system as an example of the control which selects a communication path. This wireless communication system comprising wireless terminals and a base station transmits a simultaneous broadcast signal under the control of the base station in accordance with, e.g., the communication traffic amount or whether or not the base station is in operation, thereby switching between a wireless communication path which is transmitted via the base station and a wireless communication path which is not. This indicates that the system selects a communication path by regarding all the wireless terminals accommodated in the system as equal, and using only the parameters (the communication traffic and the state of the base station) on wireless communication as communication path selection conditions.

Also, patent reference 2 (U.S. Pre-Grant Publication No. 2004/240,405 (Japanese Patent Laid-Open No. 2004-363645)) describes a technique as an example of the communication path selection control. In this technique, a transmission source terminal selects whether to transmit data directly between terminals or via a base station, in accordance with whether the transmission data is real-time data and with the total transmission band amount necessary for the transmission. That is, a transmission device as a transmission source selects a communication path. Also, a communication path is selected in accordance with whether data to be transmitted is real-time data, and whether the communication path can ensure an open transmission band to communicate the data.

In each of the inventions described in patent references 1 and 2 described above, the system comprising the base station and terminals selects whether to perform communication between the terminals via the base station or directly under the following conditions. That is, the system selects a communication path in accordance with whether data to be transmitted is real-time data, whether the communication path can ensure an open transmission band to communicate the data, the communication traffic amount, and whether the base station is in operation.

This is equivalent to selecting a communication path by regarding all the terminals as equal, and using only the various parameters (the type of transmission data, the use band, the communication traffic, and the operating state of the base station) on wireless communication as communication path selection conditions.

Even when communication is performed by selecting a direct communication path between the terminals under the above conditions, a radio wave does not reach a terminal any longer if the terminal moves, and this makes direct communication between the terminals impossible in some places. In this case, the communication may be interrupted. On the other hand, when a communication path transmitted via the base station is selected, the communication is not interrupted as long as the terminals move within the management area of the base station. That is, although an optimum communication path can be selected in accordance with the communication traffic amount, this communication path is not always optimal for the system.

In addition, in the invention described in patent reference 2, not the control station but the device as a data transmission source selects a communication path.

In this case, the system requires a mechanism which allows each transmission device to detect whether all the transmission devices accommodated in the system are terminals which move during communication, whether each terminal is dedicated to transmit or receive data, and the present status of each terminal in the system. To select the optimum communication path for the system, therefore, each transmission device must detect the conditions of the entire system, increasing the processing load. Also, each transmission device must be equipped with this function.

### SUMMARY OF THE INVENTION

The present invention has been made to solve the above problems, and has as its object to select a communication path connecting wireless terminals via a communication apparatus or a communication path directly connecting the wireless terminals in accordance with the statuses of the wireless terminals, when transmitting data between the wireless terminals.

According to an aspect of the present invention, there is provided a communication path setting method of a communication system including a communication apparatus and a plurality of wireless terminals accommodated in the communication apparatus, comprising:

a recording step of recording statuses of the plurality of accommodated wireless terminals; and

a selecting step of selecting, when transferring data between wireless terminals, one of a first communication path which connects the wireless terminals via the communication apparatus, and a second communication path which directly connects the wireless terminals without via the communication apparatus, in accordance with statuses of the wireless terminals.

According to another aspect of the present invention, there is provided a communication apparatus accommodating a plurality of wireless terminals by wireless, comprising:

a recording unit adapted to record statuses of the plurality of accommodated wireless terminals; and

a selecting unit adapted to, when transferring data between wireless terminals, select one of a first communication path which connects the wireless terminals via the communication apparatus, and a second communication path which directly connects the wireless terminals without via the communication apparatus, in accordance with statuses of the wireless terminals.

Further features of the present invention will become apparent from the following description of exemplary embodiments (with reference to the attached drawings).

### BRIEF DESCRIPTION OF THE DRAWINGS

FIG. 1 is a view showing an example of the representative configuration of a wireless video transmission system according to the first embodiment;

FIG. 2 is a functional block diagram showing an example of the internal arrangement of a QSTA 101 as a video input device;

FIG. 3 is a functional block diagram showing an example of the internal arrangement of a QSTA 102 as a video input device;

FIG. 4 is a functional block diagram showing an example of the internal arrangement of a QAP 103;

FIG. 5 is a flowchart showing a process of registering management data at an access point;

FIG. 6 is a flowchart showing a process of registering management data at an access point;

FIG. 7 is a view showing an example of the arrangement of a management data recording unit 402 according to the first embodiment;

FIG. 8 is a flowchart showing a communication path selection process according to the first embodiment;

FIG. 9 is a view showing an example of communication path selection in a wireless transmission system;

FIG. 10 is a functional block diagram showing an example of the internal arrangement of a QSTA 101 according to the third embodiment;

FIG. 11 is a functional block diagram showing an example of the internal arrangement of a QSTA 102 according to the third embodiment; and

FIG. 12 is a view showing the configuration of a wireless video transmission system according to the fourth embodiment.

### DESCRIPTION OF THE EMBODIMENTS

Best modes for carrying out the invention will be explained in detail below with reference to the accompanying drawings. DLS (Direct Link Setup) defined by the IEEE 802.11 standards and by the IEEE 802.11e standards as an extended version of the IEEE 802.11 standards is particularly used for wireless communication. However, the present invention is not limited to DLS, and is of course applicable to a communication control method complying with another communication protocols.

### First Embodiment

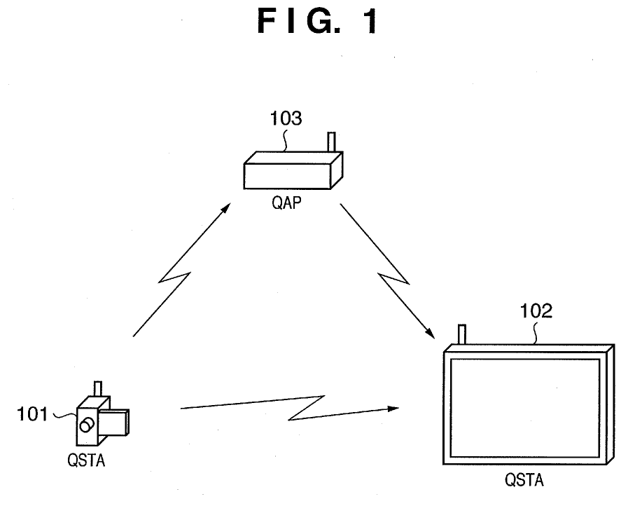

FIG. 1 is a view showing an example of the representative configuration of a wireless video transmission system according to the first embodiment. Referring to FIG. 1, reference numeral 101 denotes a wireless terminal (QSTA) having a video data transmitting function. For example, the QSTA 101 is a digital video camera capable of transmitting video streams by using a wireless LAN communication function. Reference numeral 102 denotes a wireless terminal (QSTA) having a video data receiving function. For example, the QSTA 102 is a television set capable of receiving video streams by using a wireless LAN communication function. Reference numeral 103 denotes an access point (QAP) accommodating the QSTAs 101 and 102, e.g., an access point of a wireless LAN. The QSTAs 101 and 102 establish a logical connection relationship (association) with the QAP 103, thereby forming an infrastructure mode network (BSS) of the QAP 103.

When transmitting an image recorded by the digital video camera 101 to the television set 102 and displaying the image on the television set 102, two transmission path are possible as video data transmission paths. One is a method of transmitting video data via the access point 103, and the other is a method of transmitting video data directly between the digital video camera 101 and television set 102.

The method of transmitting video data via the QAP 103 first forms a communication path from the QSTA 101 to the QAP 103, and a communication path from the QAP 103 to the QSTA 102. The method then transmits the video data from the QSTA 101 to the QSTA 102 via the QAP 103 by a transmission method which guarantees QoS.

On the other hand, the method of directly transmitting video data forms a direct communication path between the QSTAs 101 and 102 by using DLS, and transmits the video data directly from the QSTA 101 to the QSTA 102 by using a transmission method which guarantees QoS.

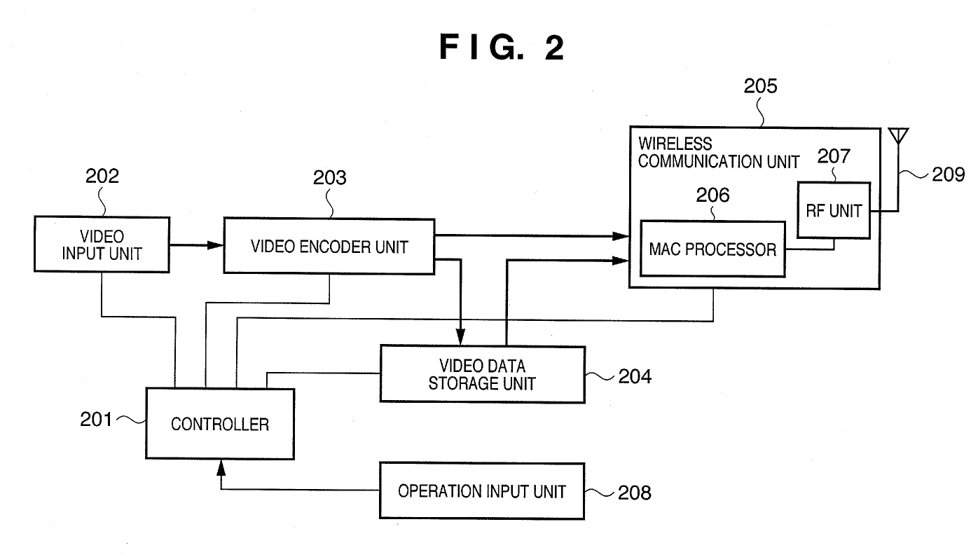

Details of the arrangements of the QSTA 101, QSTA 102, and QAP 103 will be explained below with reference to FIGS. 2 to 4.

FIG. 2 is a functional block diagram showing an example of the internal arrangement of the QSTA 101 as a video input device. A controller 201 includes a CPU which controls the whole device in accordance with programs and control data (to be described later), a ROM storing the programs and control data of the CPU, and a RAM which defines a work area used to execute processing by the CPU and various tables. A video input unit 202 comprises a camera and microphone. The video input unit 202 converts an image recorded by the camera into a digital signal, and converts a sound picked up by the microphone into a digital signal. The video input unit 202 transmits the converted video signal and audio signal to a video encoder unit in the next stage.

A video encoder unit 203 receives the video signal and audio signal transmitted from the video input unit 202, and encodes the signals into a video stream containing audio information. An example of this encoding process is a process of generating various video streams different in resolution, frame rate, and transmission rate by using various video formats such as MPEG2, MPEG4, and H.264. The controller 201 instructs the video encoder unit 203 to transmit the video stream to a video data storage unit or wireless communication unit (to be described later). That is, the video encoder unit 203 transmits the video stream to the video data storage unit when storing the video stream inside the device, and transmits the video stream to the wireless communication unit when distributing the video stream as a live image to the QSTA 102 as a video display device.

A video data storage unit 204 stores the video stream obtained by recording. The video data storage unit 204 is, e.g., a storage medium such as a DV tape, DVD, or CF card as a removable medium, or a storage medium such as an HDD as a fixed medium. Note that the video stream stored in the video data storage unit 204 is already encoded into a predetermined video format by the video encoder unit 203 during recording.

A wireless communication unit 205 has a function of transmitting and receiving radio waves in accordance with the standards (IEEE 802.11) of a wireless LAN, and operates as a wireless terminal connecting to the QAP 103 under the control of the controller 201. When distributing the recorded image as a live image to the QSTA 102 in the BSS, the wireless communication unit 205 modulates the video stream and transmits it on a radio wave from an antenna 209. The interior of the radio communication unit 205 is roughly divided into two functional blocks, i.e., a MAC processor 206 and RF unit 207.

The MAC processor 206 processes a MAC (Medium Access Control) layer complying with the wireless LAN standards (IEEE 802.11). That is, the MAC processor 206 internally forms a MAC frame, and exchanges the MAC frame with the REF unit 207. This MAC frame stores the video stream transmitted from the video encoder unit 203 in the frame body. The MAC processor 206 also stores, in the MAC frame, various kinds of information (e.g., setting information, address information, authentication information, and sequence control information) on a wireless communication channel, and exchanges the information with the RF unit 207 under the control of the controller 201.

The MAC processor 206 also has a function of operating as a wireless terminal in the BSS. This function controls wireless communication in accordance with the various kinds of information (e.g., setting information, address information, authentication information, and sequence control information) in the MAC frame controlled by the QAP 103. For real-time data transmission such as video streaming transmission, the MAC processor 206 supports a band guarantee mechanism defined by IEEE 802.11e, i.e., can reserve a band necessary for the transmission, and preferentially transmit the data by giving it a priority order. That is, the MAC processor 206 performs a process of ensuring QoS in a wireless communication path.

Furthermore, the MAC processor 206 supports a DLS function defined by IEEE 802.11e. When instructed to activate DLS by the controller 201, the MAC processor 206 activates DLS, and forms a direct communication path with respect to a desired wireless terminal in the BSS.

The RF unit 207 exchanges radio wave signals via the antenna 209 in the wireless communication unit 205. The main functions include a function of performing various modulating processes on a bit stream transmitted from the MAC processor 206 and transmitting the bit stream as a radio wave from the antenna 209, and a function of extracting a bit stream by demodulation from a radio wave received by the antenna 209.

An operation input unit 208 detects a user's operation, and transmits the detection result to the controller 201. The operation input unit 208 comprises of a key pad, push switches, slide switches, and the like, and has a function of detecting activation of each key or switch, and transmits the detection result to the controller 201.

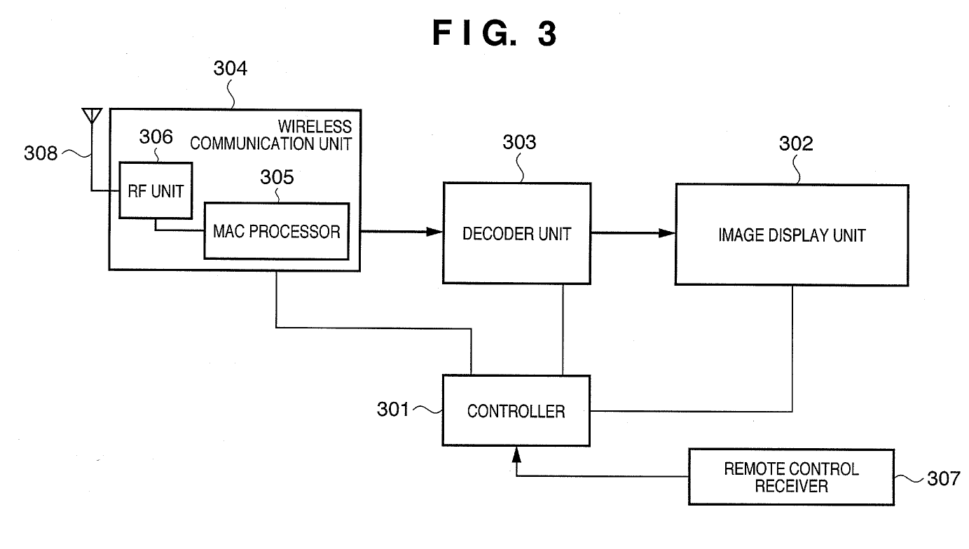

FIG. 3 is a functional block diagram showing an example of the internal arrangement of the QSTA 102 as a video display device. FIG. 3 shows the functions of individual functional blocks by taking a process of receiving a video stream and displaying the received video stream on the screen as an example. A controller 301 includes a CPU which controls the whole device in accordance with programs and control data (to be described later), a ROM storing the programs and control data of the CPU, and a RAM which defines a work area used to execute processing by the CPU and various tables.

A wireless communication unit 304 has a function of transmitting and receiving radio waves in accordance with the standards (IEEE 802.11) of a wireless LAN, and operates as a wireless terminal connecting to the QAP 103 under the control of the controller 301. When receiving video data as a video stream from the QSTA 101 in the BSS, the wireless communication unit 304 demodulates a radio wave signal received from an antenna 308 into the video stream. The interior of the radio communication unit 304 is roughly divided into two functional blocks, i.e., a MAC processor 305 and RF unit 306.

The RF unit 306 exchanges radio wave signals via the antenna 308 in the wireless communication unit 304. The main functions include a function of performing various modulating processes on a bit stream transmitted from the MAC processor 305 and transmitting the bit stream as a radio wave from the antenna 308, and a function of extracting a bit stream by demodulation from a radio wave received by the antenna 308.

The MAC processor 305 processes the MAC (Medium Access Control) layer in accordance with wireless LAN standards (IEEE 802.11). That is, the MAC processor 305 internally forms a MAC frame, and exchanges the MAC frame with the REF unit 306. The MAC processor 305 extracts a video stream from the frame body of this MAC frame, and transmits the extracted video stream to a decoder unit 303. The MAC processor 305 also stores, in the MAC frame, various kinds of information (e.g., setting information, address information, authentication information, and sequence control information) on a wireless communication channel, and exchanges the information with the RF unit 306 under the control of the controller 301.

The MAC processor 305 also has a function of operating as a wireless terminal in the BSS. This function controls wireless communication in accordance with the various kinds of information (e.g., setting information, address information, authentication information, and sequence control information) in the MAC frame controlled by the QAP 103. For real-time data transmission such as video streaming transmission, the MAC processor 305 supports a band guarantee mechanism defined by IEEE 802.11e, i.e., can preserve a band necessary for the transmission, and preferentially transmit the data by giving it a priority order. That is, the MAC processor 305 performs a process of ensuring QoS in a wireless communication path.

Furthermore, the MAC processor 305 supports a DLS function as defined by IEEE 802.11e. When instructed to activate DLS by the controller 301, the MAC processor 305 activates DLS, and forms a direct communication path with respect to a desired wireless terminal in the BSS.

The decoder unit 303 converts the received video stream into a video signal to be displayed on the screen. The decoder unit 303 transmits the decoded video signal to an image display unit 302. When requested to display a video stream on the image display unit 302, the decoder unit 303 decodes the video signal under the control of the controller 301, thereby generating a video signal converted into an image size corresponding to the image display unit 302.

The image display unit 302 displays a video stream on the screen. That is, the image display unit 302 displays the video signal transmitted from the decoder unit 303 under the control of the controller 301.

A remote control receiver 307 receives control signals transmitted by communication such as infrared radiation from a remote controller (not shown) which remotely controls the QSTA 102. For example, when receiving a control signal for switching images currently being displayed on the screen from the remote controller, the remote control receiver 307 interprets the contents of the received control signal, and notifies the controller 301 of the contents.

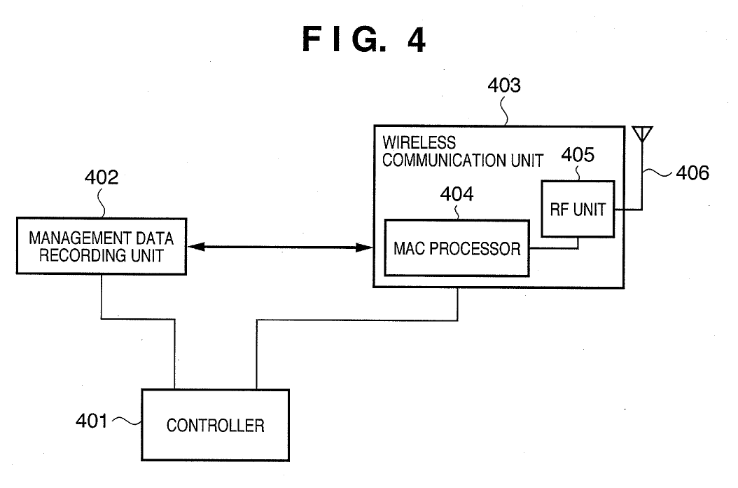

FIG. 4 is a functional block diagram showing an example of the internal arrangement of the QAP 103. Referring to FIG. 4, a controller 401 includes a CPU which controls the whole device in accordance with programs (to be described later), a ROM storing the programs of the CPU and control data, and a RAM which defines a work area used to execute processing by the CPU and various tables.

A wireless communication unit 403 has a function of transmitting and receiving radio waves in accordance with wireless LAN standards (IEEE 802.11). The wireless communication unit 403 operates as an access point which forms a ESS together with connected wireless terminals under the control of the controller 401. When receiving video data or control data from a wireless terminal in the BSS, the radio communication unit 403 demodulates the video data or control data received from an antennal 406 via a radio wave. When transmitting video data or control data to a wireless terminal in the BSS, the radio communication unit 403 transmits modulated data as a radio wave from the antenna 406. The interior of the radio communication unit 403 is roughly divided into two functional blocks, i.e., a MAC processor 404 and RF an unit 405.

The RF unit 405 exchanges radio wave signals via the antenna 406 in the wireless communication unit 403. The main functions include a function of performing various modulating processes on a bit stream transmitted from the MAC processor 404 and transmitting the bit stream as a radio wave from the antenna 406, and a function of extracting a bit stream by demodulation from a radio wave received by the antenna 406.

The MAC processor 404 processes the MAC (Medium Access Control) layer in accordance with the wireless LAN standards (IEEE 802.11). That is, the MAC processor 404 internally forms a MAC frame, and exchanges the MAC frame with the RE unit 405. For example, when transmitting video data from the QSTA 101 to the QSTA 102 via the QAP 103 shown in FIG. 1, the MAC processor 404 analyzes a MAC frame received from the QSTA 101, and changes the MAC header in accordance with a predetermined process and sequence. The MAC processor 404 then forms a MAC frame again, and transmits the MAC frame to the QSTA 102.

Also, when video data is directly transmitted between the QSTAs 101 and 102 using DLS, the MAC processor 404 forms a control MAC frame, and transmits a control signal to the wireless terminals (QSTAs 101 and 102) in accordance with a predetermined timing.

In addition, when receiving, from a wireless terminal, a request to form a new communication path, a request to form a communication path by DLS, or a request for transferring various data, the MAC processor 404 performs QAP control executed as MAC layer processing.

Furthermore, the MAC processor 404 has a function of analyzing various pieces of information (e.g., setting information, address information, authentication information, and sequence control information) in the received MAC frame, and transmitting the obtained information to a management data recording unit 402.

The management data recording unit 402 records management data concerning wireless terminals in the BSS formed by the QAP 103. The management data recording unit 402 comprises a RAM (Random Access Memory) capable of data write and read, and records not only the MAC layer information obtained by the MAC processor 404 but also information obtained by upper layers. For example, the management data recording unit 402 records not only information regarding the type of wireless terminal obtained by the MAC layer, but also information obtained by a protocol or application as an upper layer of the MAC layer, e.g., information indicating that the wireless terminal is a television set or digital video camera.

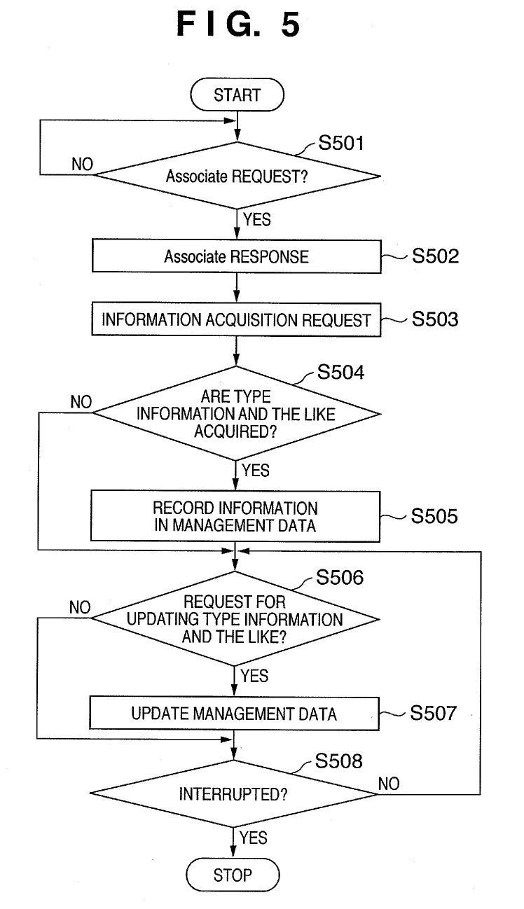

A process of registering management data in the management data recording unit 402 of the QAP 103 will be explained below with reference to FIG. 5.

FIG. 5 is a flowchart showing the process of registering management data at an access point. Note that this process is executed when the access point (QAP 103) constructs an infrastructure mode network (BESS), and the wireless terminal (QSTA) in the BSS performs association (connection).

First, in step S501, the QAP 103 determines whether the wireless terminal (QSTA 101 or 102) in the BSS at the QAP 103 has issued an association request (connection relationship request). If the wireless terminal (QSTA 101 or 102) has issued a connection relationship request, the process advances to step S502; if not, the QAP 103 maintains the present state.

In step S502, the QAP 103 transmits an association response indicating whether to admit the connection relationship, in response to the association request. The QAP 103 also records information elements (e.g., Capability Information and Listen Interval)

defined by IEEE 802.11 into the management data recording unit 402 for each wireless terminal having transmitted the elements. The information elements are wireless terminal information in the MAC layer, and the MAC processor 404 detects and extracts the elements.

In step S503, the QAP 103 transmits a signal requesting information other than the information elements acquired in step S502. Although the wireless terminal information acquired in step S502 is information in the MAC layer, the above signal requests the wireless terminal (QSTA 101 or 102) for wireless terminal information processed in an upper layer (an upper protocol or application layer). An example of the requested wireless terminal information is type information indicating whether the wireless terminal is a digital video camera as a video data transmitter or a television set as a video data receiver.

In step S504, the QAP 103 determines whether the wireless terminal (QSTA 101 or 102) has transmitted a valid response to the transmitted request. If the wireless terminal has transmitted a valid response, the process advances to step S505; if not, the process advances to step S506. Whether the response is valid is determined in accordance with whether the wireless terminal information requested in step S503 is obtained.

In step S505, the QAP 103 records the wireless terminal information obtained in the response from the wireless terminal into the management data recording unit 402. Since the obtained wireless terminal information is transmitted as is described in the frame body of the MAC frame, not the MAC processor 404 but the controller 401 capable of analyzing the frame body detects and extracts the information.

In step S506, the QAP 103 determines whether the wireless terminal (QSTA 101 or 102) has newly issued a wireless terminal information update request after the association process is complete. The update request is a request to update the obtained wireless terminal information because the state of the wireless terminal has changed. If the wireless terminal has issued the update request, the process advances to step S507; if not, the process advances to step S508.

In step S507, the QAP 103 additionally records wireless terminal information newly obtained by the update request from the wireless terminal into the management data recording unit 402, or updates the record. Since the newly obtained wireless terminal information is transmitted as is described in the frame body of the MAC frame, not the MAC processor 404 but the controller 401 capable of analyzing the frame body detects and extracts the information.

In step S508, the QAP 103 determines whether interruption to the QAP 103 such as a power OFF has occurred. If interruption such as a power OFF of the QAP 103 has occurred, the QAP 103 terminates the process; if not, the process returns to step S506. After the wireless terminal (QSTA 101 or 102) has executed and completed the association process with respect to the QAP 103, the QAP 103 waits for a wireless terminal information update request from a new wireless terminal (QSTA 101 or 102).

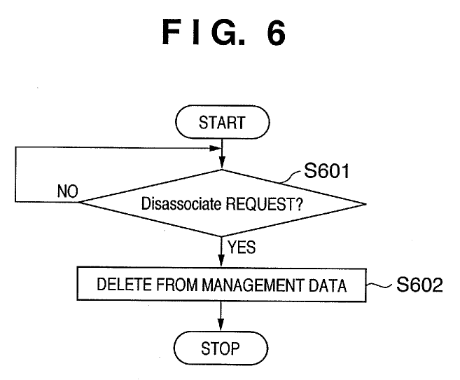

A process of deleting management data recorded in the management data recording unit 402 of the QAP 103 will be explained next with reference to FIG. 6.

FIG. 6 is a flowchart showing a process of management data registration at the access point. Note that this process is performed when the wireless terminal has executed a disassociation from the access point.

First, in step S601, the CPU 401 of the QAP 103 determines whether the wireless terminal (QSTA 101 or 102) in the BSS has issued a disassociation request for canceling association. If the disassociation request is received from the wireless terminal (QSTA 101 or 102), the process advances to step S602, and the CPU 401 deletes all information concerning the wireless terminal (QSTA 101 or 102) recorded in the management data recording unit 402. “All information” includes the information elements in the MAC layer, and the wireless terminal information recorded in step S505 shown in FIG. 5.

The deleting process can also be performed by a method which additionally records, in the management data recording unit 402, information indicating that the disassociation process of the wireless terminal (QSTA 101 or 102) was executed, as disassociation information.

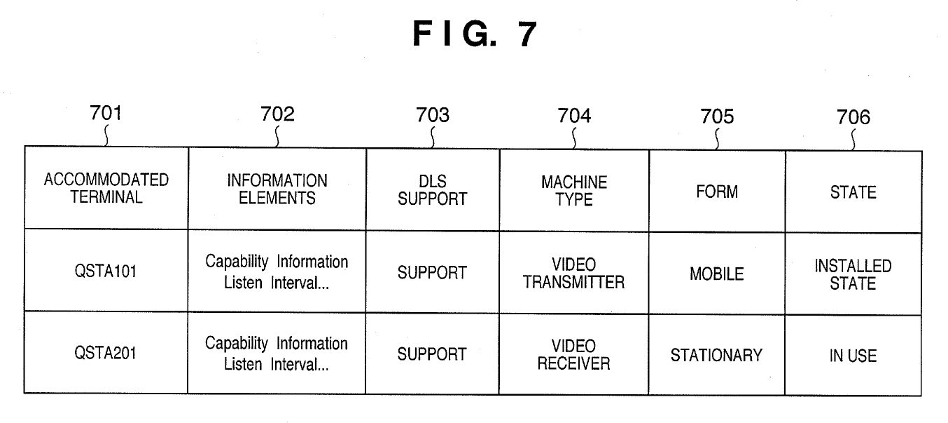

The information recorded in the management data recording unit 402 of the QAP 103 will be explained below with reference to FIG. 7.

FIG. 7 is a view showing an example of the arrangement of the management data recording unit 402 according to the first embodiment. In FIG. 7, reference numeral 701 denotes an accommodated terminal whose field records the names of wireless terminals accommodated under the management of the QAP 103; and 702, an information element whose field records the MAC layer information elements obtained from a wireless terminal when an association request is issued. Note that these information elements are defined by IEEE 802.11, and examples are the MAC address, Capability Information, and Listen Interval.

Reference numeral 703 denotes DLS support the field of which records a MAC layer information element obtained from a wireless terminal, e.g., information indicating whether the wireless terminal supports DLS. Note that this information is an information element defined by IEEE 802.11e. Reference numeral 704 denotes machine type information the field of which records information obtained by a protocol or application layer as an upper layer of the MAC layer obtained from a wireless terminal. For example, information indicating whether the wireless terminal has a video data transmitting function or receiving function is recorded. More specifically, when the wireless terminal is a television set, information indicating that the wireless terminal is a video data receiving apparatus is recorded.

Reference numeral 705 denotes form information the field of which records information obtained by a protocol or application layer as an upper layer of the MAC layer obtained from a wireless terminal. For example, information indicating the manner of use of the wireless terminal, i.e., whether the wireless terminal is stationary and kept unmoved or moved together with the user who is carrying it is recorded. More specifically, if the wireless terminal is a portable television set, information indicating that the wireless terminal is an apparatus which may move while receiving video data is recorded.

Reference numeral 706 denotes state information the field of which records information obtained by a protocol or application layer as an upper layer of the MAC layer obtained from a wireless terminal. For example, information indicating whether the wireless terminal is in a movable state or in a video data-receivable state or transmittable state is recorded. More specifically, if the wireless terminal is a television set and currently being used, e.g., the user is watching television broadcasting on the wireless terminal, information indicating that the wireless terminal is presently incapable of receiving wireless video data is recorded.

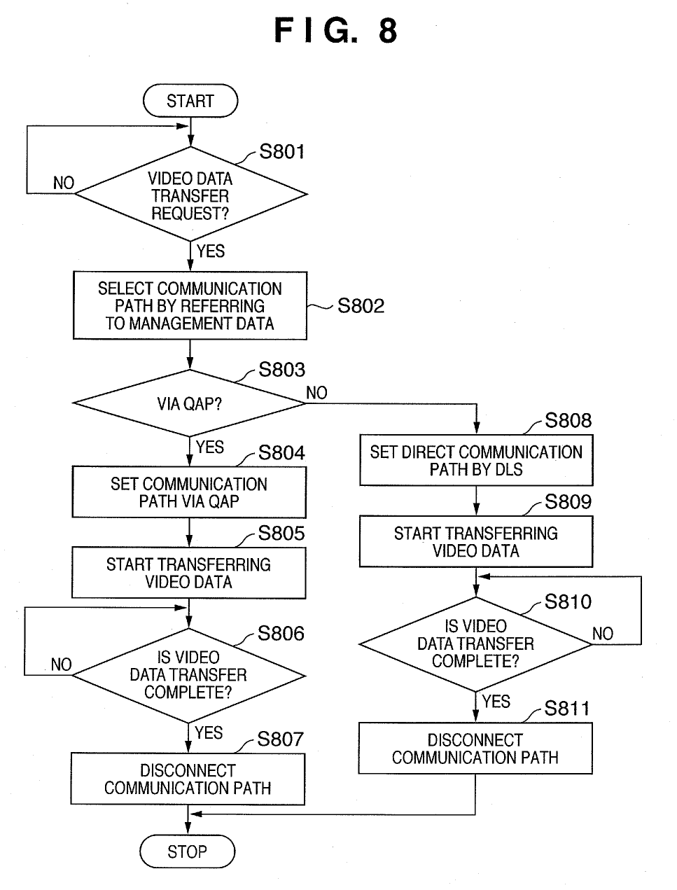

A process of selecting a communication path by referring to the recorded contents of the management data recording unit 402 of the QAP 103 when transmitting video data from the QSTA 101 to the QSTA 102 in the wireless video transmission system shown in FIG. 1 will be explained below with reference to FIG. 8. For example, this process selects whether to transmit video data using a communication path which goes via the QAP 103, or by forming a direct communication path between the QSTAs 101 and 102 using the mechanism of DLS. The process then establishes a communication path in accordance with the selection result, and transmits the video data.

Also, the QAP 103 performs this process after the wireless terminal (QSTA 101 or 102) in the BSS of the QAP 103 has executed the association request.

FIG. 8 is a flowchart showing the communication path selection process according to the first embodiment. First, in step S801, the QAP 103 determines whether the QSTA 101 has issued a request to transmit video data to the QSTA 102. More specifically, the QAP 103 determines whether the QAP 103 has received, from the QSTA 101, information indicating that the user has issued the above request in an application layer as an upper layer of the MAC layer. The user inputs the above request to the operation input unit 208 of the QSTA 101, and the controller 201 of the QSTA 101 detects the operation. The wireless communication unit 205 of the QSTA 101 describes the request information in the frame body of the MAC frame, and transmits the frame on a radio wave to the QAP 103.

If the QSTA 101 has issued a request for transmission of video data to the QSTA 102, the process advances to step S802, the QAP 103 refers to the information in the management data recording unit 402, and the controller 401 selects a communication path. More specifically, the controller 401 reads out management data concerning the corresponding wireless terminals (QSTAs 101 and 102) from the management data recording unit 402. If “support” is recorded in the DLS support 703 and “stationary” is recorded in the form 705 of the QSTA 102, the controller 401 selects a direct communication path to be formed between the QSTAs 101 and 102 by DLS.

If “mobile” is recorded in the form 705 of the QSTA 102, the controller 401 selects a communication path which connects the QSTAs 101 and 102 via the QAP 103.

In step S803, the QAP 103 determines whether the communication path selected in step S802 goes via the QAP 103. If the selected communication path goes via the QAP 103, the process advances to step 5804. If the selection is made to form a direct communication path between the QSTAs 101 and 102, the process advances to step S808.

In step S804, the QAP 103 notifies the QSTA 101 that the communication path for transmitting video data to the QSTA 102 goes via the QAP 103. The QSTA 101 having received this notification forms a communication path to the QSTA 102 via the QAP 103. In this step, the process, in which the QAP 103 notifies the QSTA 101 that the communication path for transmitting video data to the QSTA 102 goes via the QAP 103, is performed as follows.

In an application layer as an upper layer of the MAC layer, the controller 401 controls the wireless communication unit 403 to describe the notification information in the frame body of the MAC frame, and transmit the frame on a radio wave to the QSTA 101. The QSTA 101 having received the notification forms a communication path to the QSTA 102 via the QAP 103 in accordance with a communication protocol defined by a wireless LAN complying with IEEE 802.11 and IEEE 802.11e.

In step S805, the QAP 103 instructs the QSTA 101 to begin transmitting the video data by the communication path established in step S804. In step S806, the QAP 103 determines whether a user operation or the like has been performed to stop the video data transmission currently being performed. If a user operation or the like has been performed to stop the video data transmission currently being performed, the process advances to step S807; if not, the QAP 103 maintains the present state.

In step S807, the QAP 103 disconnects the communication path formed from the QSTA 101 to the QSTA 102 via the QAP 103. Similar to the communication path established process in step S804, this process also disconnects the communication path formed via the QAP 103 in accordance with the communication protocol defined by the wireless LAN.

Furthermore, in step S808, the QAP 103 notifies the QSTA 101 that the communication path for transmitting video data to the QSTA 102 directly connects the QSTAs 101 and 102 using the DLS mechanism. The QSTA 101 having received this notification requests the QAP 103 to form a communication path which directly connects the QSTAs 101 and 102 using the DLS mechanism. In this step, the process in which the QAP 103 notifies the QSTA 101 that the communication path for transmitting the video data to the QSTA 102 directly connects the QSTAs 101 and 102 using the DLS mechanism is performed as follows.

In an application layer as an upper layer of the MAC layer, the controller 401 controls the wireless communication unit 403 to describe the notification information in the frame body of the MAC frame, and transmit the frame on a radio wave to the QSTA 101. The QSTA 101 having received the notification forms a direct communication path from the QSTA 101 to the QSTA 102 in accordance with a procedure defined by IEEE 802.11 and IEEE 802.11e.

In step S809, the QAP 103 instructs the QSTA 101 to start transmitting the video data through the direct communication path by DLS. In step S810, the QAP 103 determines whether a user's operation or the like has performed control to stop the video data transmission currently being performed. If a user operation or the like has been performed to stop the video data transmission currently being performed, the process advances to step S811; if not, the QAP 103 maintains the present state.

In step S811, the QAP 103 disconnects the communication path directly connected by DLS. Similar to the direct communication path setting process in step S808, this process also disconnects the communication path to the QSTA 102 formed by DLS in accordance with the procedure defined by IEEE 802.11 and IEEE 802.11e.

When the disconnecting process in step S807 or S811 is complete, the wireless terminals (QSTAs 101 and 102) return to the association state with respect to the QAP 103, and the QAP 103 terminates the process.

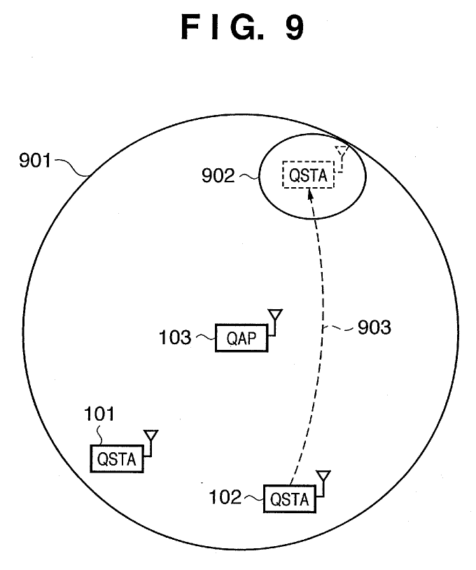

FIG. 9 is a view showing an example of a communication path selection in the wireless transmission system. The example shown in FIG. 9 indicates the operation of the flowchart shown in FIG. 8 from another viewpoint. The configuration shown in FIG. 9 is the same as that of the wireless transmission system comprising the QAP 103 and QSTAs 101 and 102 shown in FIG. 1.

In FIG. 9, reference numeral 901 denotes a circle indicating an area within which the radio wave from the QAP 103 reaches. When a wireless terminal exists in the circle 901, this wireless terminal can associate with (connect to) and communicate with the QAP 103 wirelessly.

The start state shown in FIG. 8 is a state in which the QSTAs 101 and 102 connect to the QAP 103 shown in FIG. 9. In this state, the distance between the QSTAs 101 and 102 allows them to directly communicate with each other by DLS.

If the QSTA 101 issues a request for video data transmission to the QSTA 102, a communication path connecting the QSTAs 101 and 102 is selected. If the QSTA 102 is a stationary apparatus, i.e., if the QSTA 102 is an apparatus which cannot move while displaying an image, e.g., a television set in a living room, DLS is activated to form a direct communication path between the QSTAs 101 and 102 shown in FIG. 9.

On the other hand, if the QSTA 102 is a mobile apparatus, i.e., if the QSTA 102 is an apparatus which can move while displaying an image, e.g., a portable television set, a communication path which goes from the QSTA 101 to the QSTA 102 via the QAP 103 is formed without activating DLS.

If the QSTA 102 is a stationary apparatus, it cannot move to an area 902 shown in FIG. 9 as indicated by a moving 903. If the QSTA 102 is a mobile apparatus, however, it can move to the area 902 shown in FIG. 9 as indicated by the moving 903. Although a wireless terminal in the area 902 can communicate with the QAP 103, the radio wave from the QSTA 101 may not directly reach the area 902. Accordingly, if a direct communication path is formed by activating DLS upon path selection and the QSTA 102 moves to the area 902, no radio wave reaches the QSTA 102 any longer, so video data transmission is interrupted.

The first embodiment can prevent the above problem by selecting a communication path in accordance with whether the QSTA 102 is a stationary device or mobile device in step S802 shown in FIG. 8, and transmitting video data by a communication path established in step S804 or S808 shown in FIG. 8.

### Second Embodiment

The second embodiment according to the present invention will be explained in detail below with reference to the accompanying drawings. The second embodiment will be explained by taking as an example a case in which a QSTA 101 transmits video data to a QSTA 102 while moving in the configuration shown in FIG. 1. An example is a case in which the QSTA 101 is a digital video camera which performs recording and transmits video data to the QSTA 102 in real time while moving in an area 901 shown in FIG. 9.

First, in the management data registration process shown in FIG. 5, to notify a QAP 103 that the QSTA 101 is a mobile device, information indicating that a form 705 of the QSTA 101 is mobile is recorded in a management data recording unit 402 of the QAP 103. If a video data transmission request as shown in FIG. 8 is issued after that, a communication path which goes via the QAP 103 is selected by referring to the recorded contents of the form 705. After the communication path is formed, video data transmission is started.

This makes it possible to maintain the video data transmission even when the QSTA 101 shown in FIG. 9 moves to an area 902 from which no radio wave can directly reach the QSTA 102.

### Third Embodiment

The third embodiment according to the present invention will be explained in detail below with reference to the accompanying drawings. QSTAs 101 and 102 shown in FIG. 1 are sometimes used as stationary devices or mobile devices in accordance with user's forms of use. For example, when the QSTA 101 is a digital video camera, it is sometimes used in an immovable state because it is connected to an AC plug socket by a power cable to receive power when playing back internally recorded video data. On the other hand, the QSTA 101 is sometimes used as it is moved while receiving power from a built-in battery in order to perform recording.

In another example, the user sets, in the QSTA 101, information indicating whether to move the QSTA 101 while using it.

A method of selecting a communication path in accordance with the use state, i.e., in accordance with whether to use the QSTA 101 as a stationary device or mobile device will be explained below.

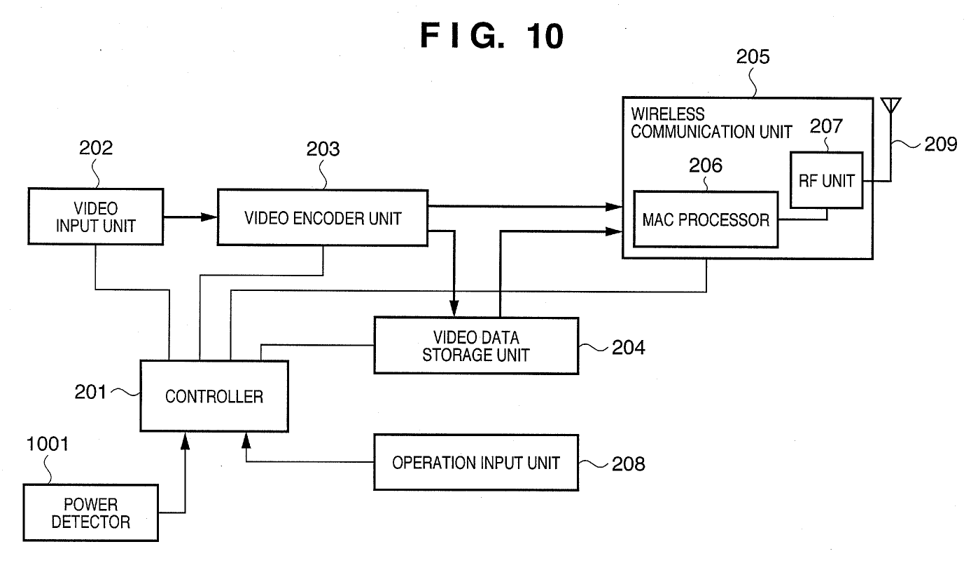

FIG. 10 is a functional block diagram showing an example of the internal arrangement of the QSTA 101 according to the third embodiment. Referring to FIG. 10, a power detecting function is added to the functions shown in FIG. 2. A power detector 1001 is a functional block for the power detecting function. The power detector 1001 has a function of detecting whether a power cable is supplying power such as AC 100 V to the QSTA 101, or a built-in battery is supplying power to the QSTA 101. Whenever detecting a change in power supply path, the power detector 1001 notifies a controller 201 of the change.

When notified by the power detector 1001 that the power supply path has changed, the controller 201 controls the QSTA 101 to notify a QAP 103 of the change. This notification is performed in accordance with the flowchart shown in FIG. 5. A management data recording unit 402 of the QAP 103 records, e.g., “mobile” in a form 705 and “installed state” in a state 706 of the QSTA 101. In this case, the power cable is supplying power to the QSTA 101.

When a video data transmission request as shown in FIG. 8 is issued after that, a communication path using DLS is selected by referring to the recorded contents of the form 705 and state 706 of the QSTA 101. After the communication path is formed, video data transmission is started.

In this example, it is unnecessary to assume that the QSTA 101 moves to an area 902 shown in FIG. 9 to which no radio wave directly comes from the QSTA 102. Therefore, video data transmission can be maintained even when the communication path using DLS is set.

On the other hand, if “mobile” is recorded in the form 705 of the QSTA 101 and “movable state” is recorded in the state 706 of the QSTA 101, the battery is supplying power to the QSTA 101. When a video data transmission request as shown in FIG. 8 is issued after that, a communication path going via the QAP 103 is selected by referring to the recorded contents of the form 705 and state 706 of the QSTA 101. After the communication path is formed, video data transmission is started.

In this example, the QSTA 101 may move to the area 902 shown in FIG. 9 to which no radio wave directly comes from the QSTA 102. Accordingly, video data transmission can be maintained by setting the communication path going via the QAP 103.

A method of selecting a communication path in accordance with the use state of the QSTA 102, i.e., in accordance with whether the QSTA 102 is used as a stationary device or mobile device will be explained below in the same manner as for the QSTA 101.

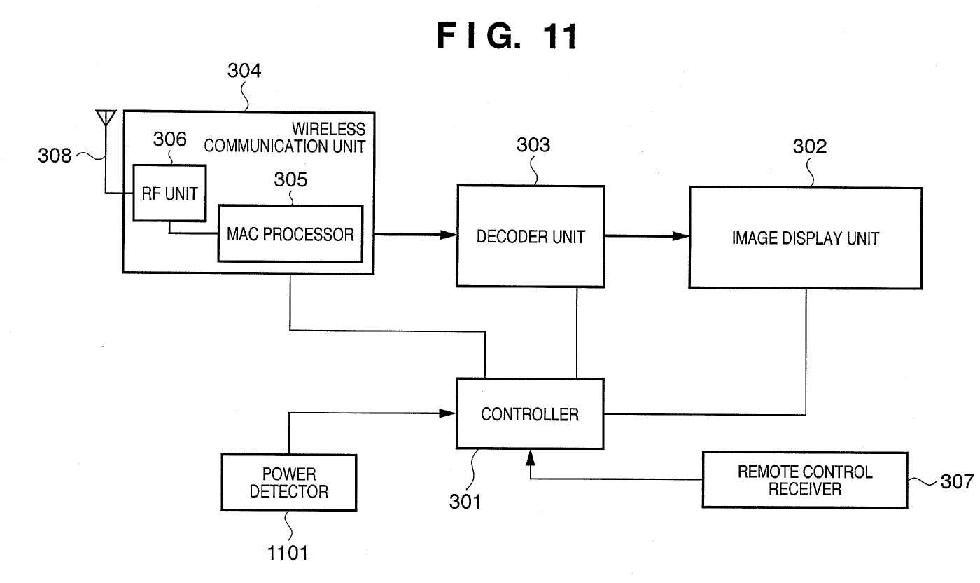

FIG. 11 is a functional block diagram showing an example of the internal arrangement of the QSTA 102 according to the third embodiment. Referring to FIG. 11, a predetermined function is added to the functions shown in FIG. 3. The added functional block is a power detector 1101. The power detector 1101 has a function of detecting whether a power cable is supplying power such as AC 100 V to the QSTA 102, or a built-in battery is supplying power to the QSTA 102. Whenever detecting a change in power supply channel, the power detector 1101 notifies a controller 301 of the change.

When notified by the power detector 1101 that the power supply path has changed, the controller 301 controls the QSTA 102 to notify the QAP 103 of the change. This notification is performed in accordance with the flowchart shown in FIG. 5. The management data recording unit 402 of the QAP 103 records, e.g., “mobile” in the form 705 and “installed state” in the state 706 of the QSTA 102. In this case, the power cable is supplying power to the QSTA 102.

When a video data transmission request as shown in FIG. 8 is issued after that, a communication path using DLS is selected by referring to the recorded contents of the form 705 and state 706 of the QSTA 102. After the communication path is formed, video data transmission is started.

In this example, it is unnecessary to assume that the QSTA 102 moves to the area 902 shown in FIG. 9 to which no radio wave directly comes from the QSTA 101. Therefore, video data transmission can be maintained even when the communication path using DLS is set.

On the other hand, if “mobile” is recorded in the form 705 of the QSTA 102 and “movable state” is recorded in the state 706 of the QSTA 102, the battery is supplying power to the QSTA 102. When a video data transmission request as shown in FIG. 8 is issued after that, a communication path going via the QAP 103 is selected by referring to the recorded contents of the form 705 and state 706 of the QSTA 102. After the communication path is formed, video data transmission is started.

In this example, the QSTA 102 may move to the area 902 shown in FIG. 9 to which no radio wave directly comes from the QSTA 101. Accordingly, video data transmission can be maintained by setting the communication path going via the QAP 103.

### Fourth Embodiment

The fourth embodiment according to the present invention will be explained in detail below with reference to the accompanying drawings. In the fourth embodiment, one wireless terminal which transmits video data and a plurality of wireless terminals which receive the video data exist in the BSS of an access point.

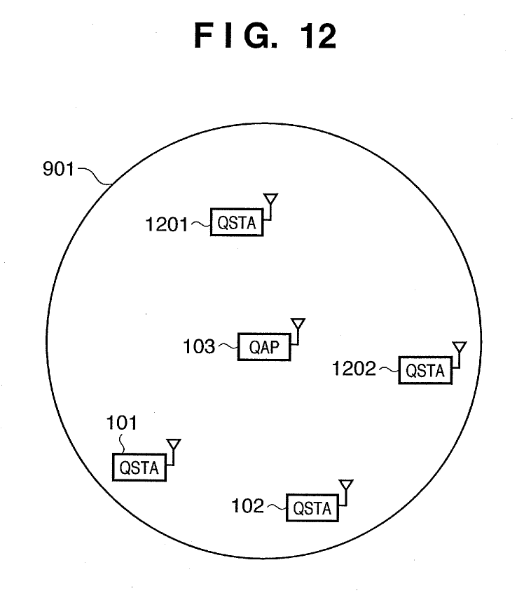

FIG. 12 is a view showing the configuration of a wireless video transmission system according to the fourth embodiment. As shown in FIG. 12, QSTAs 1201 and 1202 are added to an area 901 of a QAP 103. Each wireless terminal can associate with and communicate with the QAP 103 by wireless.

In this system configuration shown in FIG. 12, a management data recording unit 402 of the QAP 103 records one wireless terminal for which a machine type 704 is “video transmitter”, and three wireless terminals for each of which the machine type 704 is “video receiver”. If a QSTA 101 issues a video data transmission request as shown in FIG. 8 in this state, a communication path going via the QAP 103 is selected without using DLS, since there is no other wireless terminal which transmits video data.

As described above, the QAP 103 can detect by the process shown in FIG. 5 whether a wireless terminal associating with the QAP 103 is a video transmitter or video receiver. The QAP 103 can also select a communication path optimum for the system configuration by referring to the contents.

A basis for selecting a communication path going via the QAP 103 without using DLS will be explained below. In the system configuration shown in FIG. 12, the QSTA 1201 or 1202 sometimes issues a video data receiving request while the QSTA 101 is transmitting video data to a QSTA 102, regardless of a communication path.

If the QSTA 101 is directly transmitting the video data to the QSTA 102 by using DLS, the QSTA 101 must disconnect the communication path using DLS once in order to execute the request. After that, the QSTA 101 forms communication paths for the QSTA 102 and QSTA 1201 (QSTA 1202) again by using a multicast address via the QAP 103. This interrupts the reception of the video data by the QSTA 102.

To prevent this video data interruption, a communication path which goes from the QSTA 101 to the QSTA 102 via the QAP 103 is preselected. If the QSTA 1201 (QSTA 1202) in the area 901 of the QAP 103 issues a video data receiving request after that, the destination address transmitted from the QSTA 101 is changed to the multicast address. Consequently, the video data can be transmitted to the QSTA 102 and QSTA 1201 (QSTA 1202).

As described above, the QSTA 102 can receive the video data without any interruption, and the QSTA 1201 can also receive the video data.

Note that the present invention can be applied to a system constituted by a plurality of devices (e.g., a host computer, interface, reader, and printer) or to an apparatus (e.g., a copying machine or facsimile apparatus) comprising a single device.

It is of course also possible to achieve the object of the present invention by supplying a recording medium recording the program code of software for implementing the functions of the above embodiments to a system or apparatus, and reading out and executing the program code stored in the recording medium by a computer (or a CPU or MPU) of the system or apparatus.

In this case, the program code read out from the recording medium implements the functions of the above embodiments, and the recording medium storing this program code constitutes the invention.

As this recording medium for supplying the program code, it is possible to use, e.g., a flexible disk, hard disk, optical disk, magnetooptical disk, CD-ROM, CD-R, magnetic tape, nonvolatile memory card, or ROM.

Also, besides the functions of the above embodiments are implemented by executing the readout program code by the computer, the present invention naturally includes a case where an OS (Operating System) or the like running on the computer performs part or the whole of actual processing in accordance with designations by the program code, thereby implementing the functions of the embodiments.

Furthermore, the present invention of course also includes a case where the program code read out from the recording medium is written in a memory of a function expansion board inserted into the computer or of a function expansion unit connected to the computer, and a CPU or the like of the function expansion board or function expansion unit performs part or the whole of actual processing in accordance with designations by the program code, thereby implementing the functions of the above embodiments.

In the embodiments described above, when transferring data between wireless terminals, it is possible to automatically set an effective communication path from a communication path connecting the wireless terminals via a communication device, and a communication path directly connecting the wireless terminals without going via the communication device, in accordance with the statuses of the individual wireless terminals.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-342842, filed on Nov. 28, 2005, which is hereby incorporated by reference herein in its entirety.

What is claimed is:

1. A communication path setting method of a communication system including a communication apparatus and a plurality of wireless terminals accommodated in the communication apparatus, comprising:
a recording step of recording statuses of the plurality of accommodated wireless terminals; and
a selecting step of selecting, when transferring data between wireless terminals, one of a first communication path which connects the wireless terminals via the communication apparatus, and a second communication path which directly connects the wireless terminals without via the communication apparatus, in accordance with statuses of the wireless terminals.

2. The method according to claim 1, wherein in the selecting step, the first communication path is selected if at least one wireless terminal is movable in a wireless communication possible area of the communication apparatus.

3. The method according to claim 1, wherein in the selecting step, the communication path is selected in accordance with use statuses of the wireless terminals.

4. The method according to claim 1, wherein in the selecting step, the second communication path is selected if a power cable is supplying power to each of the plurality of wireless terminals.

5. The method according to claim 1, wherein in the selecting step, the first communication path is selected if a built-in battery is supplying power to at least one wireless terminal.

6. The method according to claim 1, wherein in the selecting step, the first communication path is selected if the communication apparatus accommodates only one wireless terminal having a function of transmitting data.

7. A communication apparatus accommodating a plurality of wireless terminals by wireless, comprising:
a recording unit adapted to record statuses of the plurality of accommodated wireless terminals; and
a selecting unit adapted to, when transferring data between wireless terminals, select one of a first communication path which connects said wireless terminals via the communication apparatus, and a second communication path which directly connects said wireless terminals without via the communication apparatus, in accordance with statuses of said wireless terminals.

8. The apparatus according to claim 7, wherein said selecting unit selects the first communication path if at least one wireless terminal is movable in a wireless communication possible area of the communication apparatus.

9. The apparatus according to claim 7, wherein said selecting unit selects the communication path in accordance with use statuses of said wireless terminals.

10. The apparatus according to claim 7, wherein said selecting unit selects the second communication path if a power cable is supplying power to each of the plurality of wireless terminals.

11. The apparatus according to claim 7, wherein said selecting unit selects the first communication path if a built-in battery is supplying power to at least one wireless terminal.

12. The apparatus according to claim 7, wherein said selecting unit selects the first communication path if the communication apparatus accommodates only one wireless terminal having a function of transmitting data.

13. A program which is recorded on a computer-readable recording medium, and causes a computer to execute a communication path setting method cited in claim 1.

14. A computer-readable recording medium recording a program which causes a computer to execute a communication path setting method cited in claim 1.
